(19) United States
(12) Patent Application Publication
(10) Pub. No.: US 2014/0379534 A1
(43) Pub. Date: Dec. 25, 2014

(54) Digital Retail Store Featuring Digital Slotting Fees

(71) Applicant: Robert Brazell, Salt Lake City, UT (US)

(72) Inventor: Robert Brazell, Salt Lake City, UT (US)

(21) Appl. No.: 14/315,235

(22) Filed: Jun. 25, 2014

Related U.S. Application Data
(60) Provisional application No. 61/839,303, filed on Jun. 25, 2013.

(51) Int. Cl. G06Q 30/02; G06Q 30/06

(52) U.S. Cl. CPC G06Q 30/0283; G06Q 30/0643
USPC 705/27.2; 705/26.1; 705/27.1

(57) ABSTRACT

The present invention is directed to providing a digital retail store featuring digital slotting fees. A digital retail store can be associated with or independent of a physical retail store. When associated with a physical retail store, products that are available within the physical retail store and for which a digital slotting fee has been paid can be made available within the digital retail store. A display device can be used within a physical retail store to display the digital retail store to a customer. A digital retail store can also be personalized for each customer of the digital retail store. A manufacturer can pay a digital slotting fee to have its products or services featured within the digital retail store pertaining to a particular customer.

### CROSS-REFERENCE TO RELATED APPLICATIONS

This application claims the benefit of U.S. Provisional Patent Application No. 61/839,303 which was filed on Jun. 25, 2014.

### BACKGROUND

In traditional brick-and-mortar retail stores, a retailer charges a manufacturer a slotting fee for placing the manufacturer's products on the shelves of the store. In essence, the slotting fee is a form of rental fee for the space on the shelf where the manufacturer's products are placed. A typical slotting fee may be calculated based on the number of inches occupied by the manufacturer's products, and may be paid on a monthly or yearly basis. In such arrangements, the manufacturer typically pays the slotting fee regardless of the number of the manufacturer's products that sale during the applicable period.

One reason why retailers charge slotting fees is due to the limited shelf space available. The slotting fees help ensure that the available shelf space is allocated to products that consumers want since manufacturers are unlikely to pay an oftentimes large slotting fee for a product that may not sale. However, some opponents of slotting fees argue that they serve as a barrier to entry for smaller companies who do not have the resources to pay or risk paying slotting fees on a new product.

### BRIEF SUMMARY

The present invention extends to methods, systems, and computer program products for providing a digital retail store featuring digital slotting fees. A digital retail store can be associated with a physical retail store. Products that are available within the physical retail store and for which a digital slotting fee has been paid can be made available within the digital retail store.

For example, a manufacturer can digitally stock products in a digital retail store to drive sales of products that are physically stocked in a physical retail store. A display device can be used within a physical retail store to display the digital retail store to a customer. A manufacturer can digitally stock its products in the digital retail store in a manner that will drive the customer to choose the manufacturer's products that are stocked in the physical retail store. One benefit of such approaches is that the manufacturer can use less physical shelf space, and therefore pay lower physical slotting fees, while still exhibiting a sufficient presence in the physical retail store due to the exposure the customer will have to the manufacturer's products via the digital retail store.

A digital retail store can also be personalized for each customer of the digital retail store thereby creating a number of custom instances of the digital retail store. A manufacturer or other supplier can pay a digital slotting fee to have its products or services featured within the digital retail store pertaining to a particular customer. In this way, the manufacturer can individualize where its products or services are presented.

For example, using the present invention, a manufacturer can maximize the effectiveness of its available funds for promoting its products or services by selecting to stock its products or services only in digital retail stores pertaining to customers that are most likely to purchase the products or services. In this way, the overall cost of exposing a product or service to customers can be reduced while still maintaining sufficient exposure to maximize sales.

In one embodiment, the present invention is implemented as a method for providing a digital retail store featuring digital slotting fees for inclusion of products in the digital retail store. A digital retail store is created. The digital retail store comprises a plurality of products that are available within the digital retail store. A request is received from a first manufacturer requesting that a first product be made available in the digital retail store. A digital slotting fee that the first manufacturer is required to pay to have the first product made available in the digital retail store is generated. In conjunction with the receipt of payment of the digital slotting fee, the first product is added to the digital retail store such that the first product is available within the digital retail store.

In another embodiment, the present invention is implemented as computer storage media storing computer executable instructions that implement a digital retail store featuring digital slotting fees. The digital retail store comprises computer executable instructions defining a plurality of products that are available within the digital retail store, computer executable instructions which when executed generate one or more user interfaces for displaying one or more of the products available within the digital retail store, and computer executable instructions which when executed calculate a digital slotting fee to charge to a manufacturer. The digital slotting fee is based on the number of the manufacturer's products that are made available within the digital retail store.

In another embodiment, the present invention is implemented as a system for implementing a digital retail store featuring digital slotting fees. The system includes a server computing system comprising one or more processors and memory storing computer executable instructions defining a plurality of products that are available within the digital retail store, computer executable instructions which when executed generate user interface for displaying one or more of the products available within the digital retail store, and computer executable instructions which when executed calculate a digital slotting fee to charge to a manufacturer, the digital slotting fee being based on the number of the manufacturer's products that are made available within the digital retail store. The system also includes one or more client computing devices for displaying the one or more user interfaces.

This summary is provided to introduce a selection of concepts in a simplified form that are further described below in the Detailed Description. This Summary is not intended to identify key features or essential features of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computing environment in which the present invention can be implemented;

FIG. 2 illustrates an example client computing device on which a user interface of a digital retail store can be displayed;

FIG. 3 illustrates another example client computing device on which a user interface of a digital retail store can be displayed;

FIG. 4 illustrates an example user interface containing products available within a digital retail store that can be displayed to a customer;

FIG. 5 illustrates a section of a physical retail store that includes a client computing device for displaying a user interface of a digital retail store that is associated with the physical retail store; and

FIG. 6 illustrates a flowchart of an example method for providing a digital retail store featuring digital slotting fees for inclusion of products in the digital retail store.

### DETAILED DESCRIPTION

The present invention extends to methods, systems, and computer program products for providing a digital retail store featuring digital slotting fees. A digital retail store can be associated with a physical retail store. Products that are available within the physical retail store and for which a digital slotting fee has been paid can be made available within the digital retail store.

For example, a manufacturer can digitally stock products in a digital retail store to drive sales of products that are physically stocked in a physical retail store. A display device can be used within a physical retail store to display the digital retail store to a customer. A manufacturer can digitally stock its products in the digital retail store in a manner that will drive the customer to choose the manufacturer's products that are stocked in the physical retail store. One benefit of such approaches is that the manufacturer can use less physical shelf space, and therefore pay lower physical slotting fees, while still exhibiting a sufficient presence in the physical retail store due to the exposure the customer will have to the manufacturer's products via the digital retail store.

A digital retail store can also be personalized for each customer of the digital retail store thereby creating a number of custom instances of the digital retail store. A manufacturer or other supplier can pay a digital slotting fee to have its products or services featured within the digital retail store pertaining to a particular customer. In this way, the manufacturer can individualize where its products or services are presented.

For example, using the present invention, a manufacturer can maximize the effectiveness of its available funds for promoting its products or services by selecting to stock its products or services only in digital retail stores pertaining to customers that are most likely to purchase the products or services. In this way, the overall cost of exposing a product or service to customers can be reduced while still maintaining sufficient exposure to maximize sales.

In one embodiment, the present invention is implemented as a method for providing a digital retail store featuring digital slotting fees for inclusion of products in the digital retail store. A digital retail store is created. The digital retail store comprises a plurality of products that are available within the digital retail store. A request is received from a first manufacturer requesting that a first product be made available in the digital retail store. A digital slotting fee that the first manufacturer is required to pay to have the first product made available in the digital retail store is generated. In conjunction with the receipt of payment of the digital slotting fee, the first product is added to the digital retail store such that the first product is available within the digital retail store.

In another embodiment, the present invention is implemented as computer storage media storing computer executable instructions that implement a digital retail store featuring digital slotting fees. The digital retail store comprises computer executable instructions defining a plurality of products that are available within the digital retail store, computer executable instructions which when executed generate one or more user interfaces for displaying one or more of the products available within the digital retail store, and computer executable instructions which when executed calculate a digital slotting fee to charge to a manufacturer. The digital slotting fee is based on the number of the manufacturer's products that are made available within the digital retail store.

In another embodiment, the present invention is implemented as a system for implementing a digital retail store featuring digital slotting fees. The system includes a server computing system comprising one or more processors and memory storing computer executable instructions defining a plurality of products that are available within the digital retail store, computer executable instructions which when executed generate user interface for displaying one or more of the products available within the digital retail store, and computer executable instructions which when executed calculate a digital slotting fee to charge to a manufacturer, the digital slotting fee being based on the number of the manufacturer's products that are made available within the digital retail store. The system also includes one or more client computing devices for displaying the one or more user interfaces.

Example Computer Architecture and Environment

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

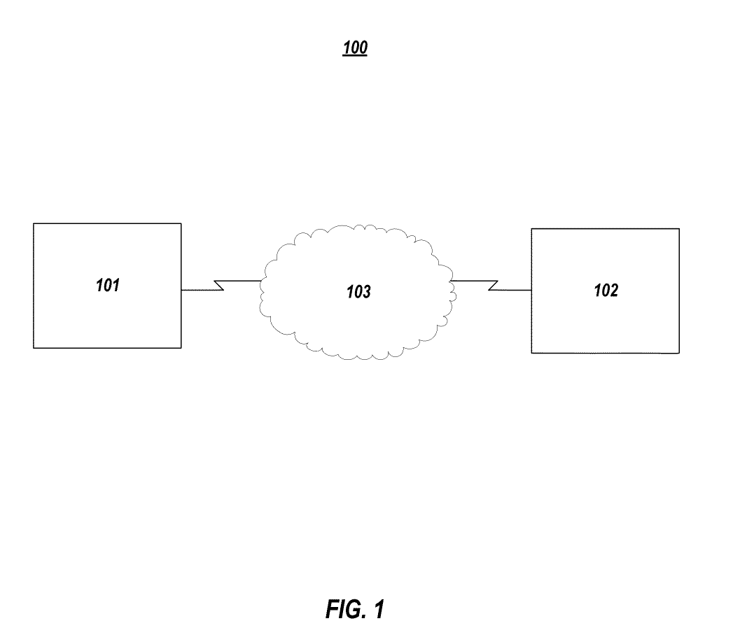

FIG. 1 illustrates an example computer environment 100 in which the present invention can be implemented. Computer environment 100 includes a server computing system 101 and a client computing device 102 that are interconnected via a network 103. Network 103 can represent any type of network for interconnected two computing systems. For example, network 103 can represent the internet or a local network. Server computing system 101 can communicate with client computing device 102 using any known communication technique or protocol.

Server computing system 101 can represent the system employed by a provider of digital retail stores while client computing device 102 can represent any device used by a customer to access a digital retail store. For example, client computing device 102 can represent a display device mounted to a shelf in a physical retail location or a customer's personal computing device (e.g. a smart phone, tablet, desktop, laptop, television, etc.).

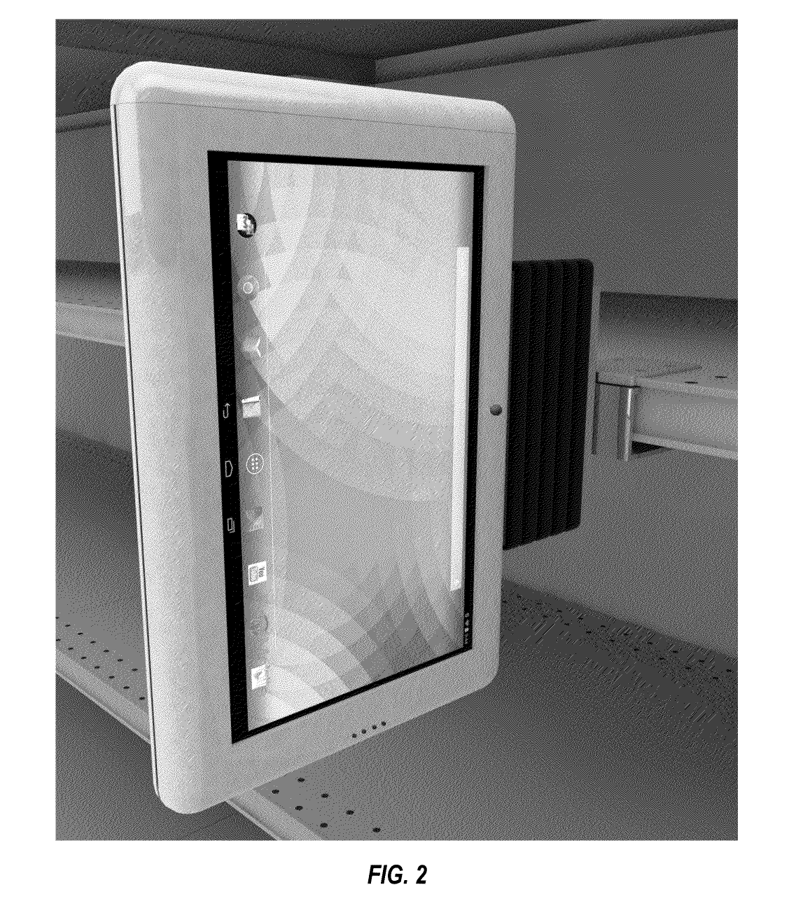

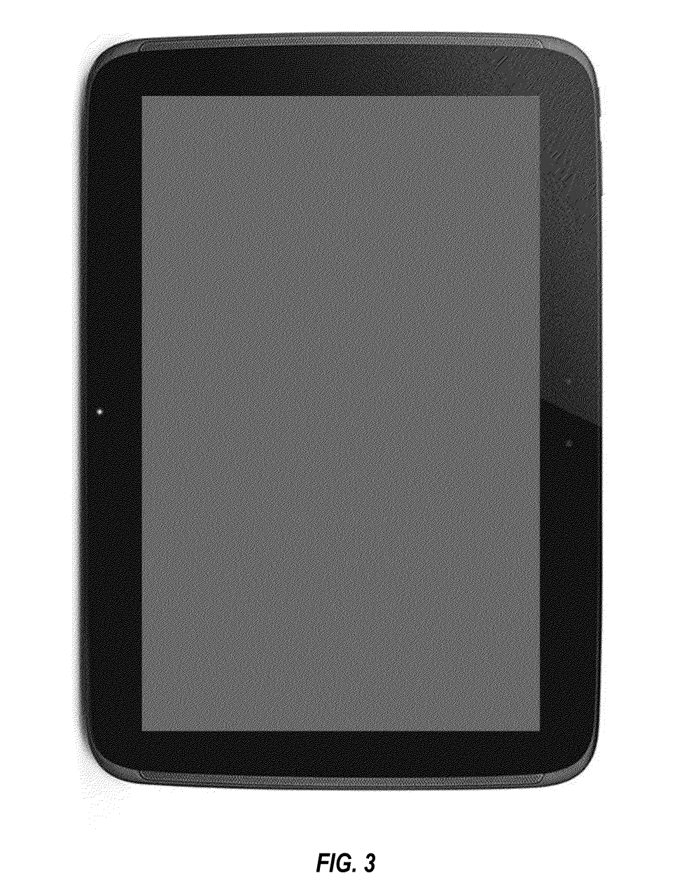

FIG. 2 illustrates a client computing device 202 that can be used in the present invention. As shown, client computing device 202 can be mounted to a shelf in a retail store. FIG. 3 also illustrates a client computing device 302 that can be used in the present invention. Client computing device 302 comprises a tablet computing device that a customer can use to access the digital retail store from virtually any location.

Providing a Digital Retail Store Featuring Digital Slotting Fees

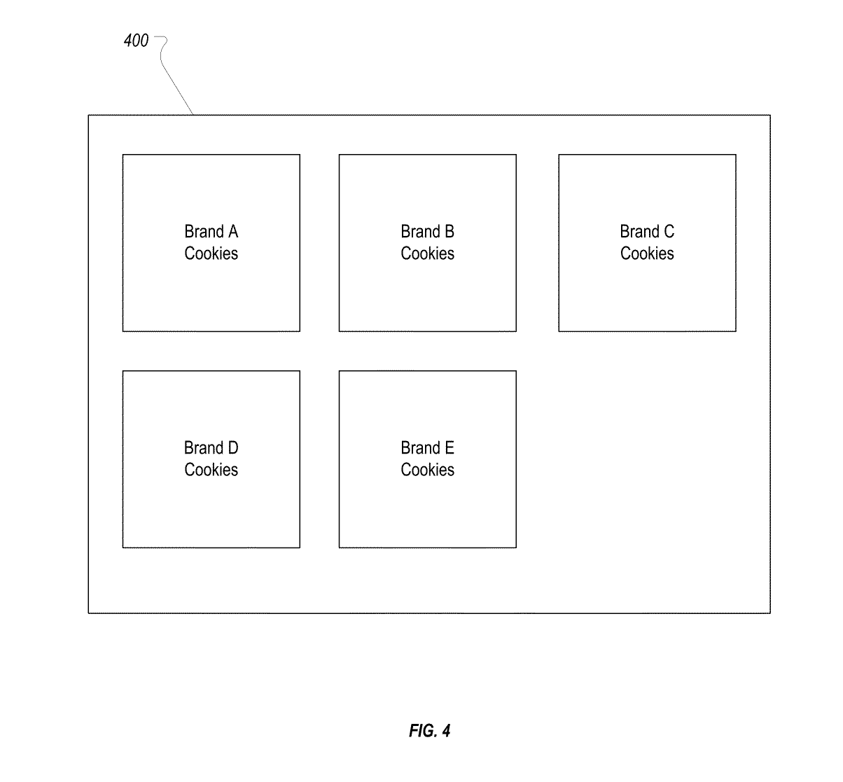

FIG. 4 illustrates an example user interface 400 that can be displayed within a digital retail store. User interface 400 displays five different brands of cookies that are available in the digital retail store. A product being available can mean that the product is available for purchase within the digital retail store (e.g. when there may not be a physical retail store associated with the digital retail store) or that the product is advertised in the digital retail store as a product that is available at an associated physical retail store.

In the example shown in FIG. 4, it will be assumed that user interface 400 displays products available within an associated physical retail store. For example, user interface 400 can be displayed on a client computing device mounted in the physical retail store similar to client computing device 202. Of course, user interface 400 can also be displayed on a customer's client computing device or any other client computing device accessible to customers whether or not the client computing device is located within a physical retail store.

User interface 400 can be displayed when a customer requests information about cookies. For example, the customer can perform a search within the digital retail store for cookies of a particular type (e.g. chocolate chip cookies). In response, the digital retail store can generate and display user interface 400 to the customer to inform the customer that five brands of cookies that match the particular type requested by the customer are available within the digital retail store. Similarly, user interface 400 can be displayed to a customer upon determining that the customer may have interest in cookies. For example, the digital retail store can identify one or more characteristics of the customer, the customer's shopping history, the customer's preferences, etc. and determine that the customer may have interest in cookies. User interface 400 can also be displayed as suggested items to consider purchasing based on one or more items the customer has already purchased, one or more items the customer has shown interest in, one or more dietary goals or restrictions the customer has, one or more recipe ideas, etc.

In any case, user interface 400 represents products that are available within the digital retail store. According to embodiments of the invention, the digital retail store can allow a product to be included in the digital retail store in exchange for payment of a digital slotting fee. For example, referring to the example of user interface 400, a manufacturer of Brand A cookies can pay a digital slotting fee to have the Brand A cookies included in the digital retail store. In this specification, the term manufacturer will be used to represent any entity that provides products or services to a retailer for sale in the retailer's store. Accordingly, the term manufacturer should be interpreted broadly to include a manufacturer or distributer of a product, a produce company, a provider of a service, or any other entity willing to pay a digital slotting fee to have a product included in a digital retail store.

In the case that the digital retail store is associated with a physical retail store, the digital retail store may not include all products that are available in the physical retail store. For example, referring again to FIG. 4, an associated physical retail store may stock ten different brands of cookies. In other words, the physical retail store may receive physical slotting fees from the manufacturers of the ten brands of cookies to have the ten brands of cookies displayed on the shelves of the store. However, if only the manufacturers of Brands A-E cookies pay the digital slotting fees to have the cookies made available in the digital retail store, only Brands A-E cookies will be included in the digital retail store as shown in user interface 400.

In this way, a manufacturer of a product can increase the visibility of its products by paying digital slotting fees to have the products included in the digital retail store. In cases where the digital retail store represents products available in a physical retail store, the digital retail store can provide a way for the manufacturer to increase the visibility of its products without necessarily paying increased physical slotting fees to have the products occupy more shelf space. For example, because the product can be included in the digital retail store by paying the digital slotting fee, customers can be informed that the product is available in the physical retail store which allows the product to occupy a smaller shelf space while still retaining a desired level of visibility.

Further, in some embodiments, because a digital retail store can be customized for individual customers, a manufacturer can pay a digital slotting fee to have its products included only in the digital retail store of customers to whom it desires to promote its products. For example, a manufacturer of diapers can determine that it only desires that its diapers are made available in digital retail stores of customers having young children. The manufacturer can therefore pay digital slotting fees only for the digital retail stores of such customers.

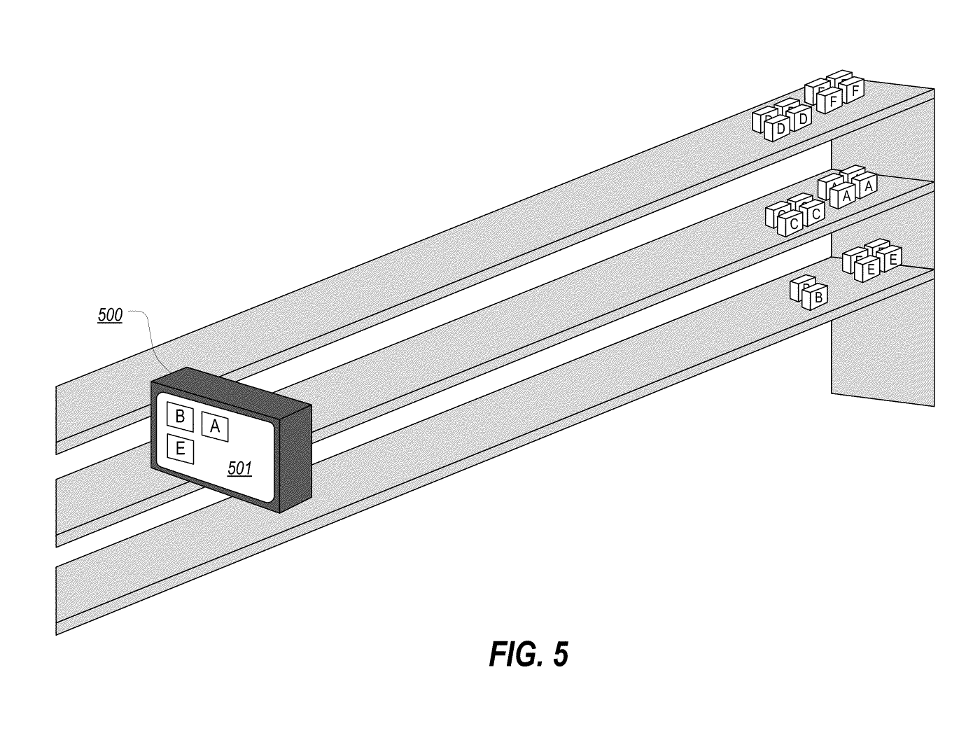

FIG. 5 illustrates an example where a client computing device 501 that is mounted to a shelf in a physical retail store is used to display a user interface 501 of a digital retail store representing products that are available within the physical retail store. In FIG. 5, six different brands or types of a product are shown as being stocked on the shelves of the physical store. In traditional practice, the manufacturer of each brand will pay a physical slotting fee to the retailer for stocking the products on the shelf of the physical retail store. In this example, the products represent hot dogs of brands A-F.

A digital retail store can be associated with the physical retail store. The digital retail store can include any products available within the physical retail store for which the manufacturer of the product has paid a digital slotting fee. For example, user interface 501 represents the user interface that can be displayed to a customer to represent hot dogs available in the digital retail store. As shown, only brands A, B, and E hot dogs are shown as being available in the digital retail store even though brands A-F are available in the physical retail store. Only brands A, B, and E hot dogs are shown in user interface 501 because digital slotting fees have only been paid for these three brands of hot dogs. When the customer views user interface 501, the customer may be influenced to purchase one of brands A, B, or E hot dogs even before the customer has visited the portion of the shelves where the hot dogs are sold.

FIG. 5 shows that brand B hot dogs occupy a smaller length of the shelf than the other brands of hot dogs. Accordingly, the manufacturer of brand B hot dogs will typically pay less in physical slotting fees. However, by paying a digital slotting fee to have the brand B hot dogs included in the digital retail store, the manufacturer of the brand B hot dogs can still maintain an increased degree of visibility of its hot dogs within the physical retail store without having to pay higher physical slotting fees to occupy a larger shelf space. For this reason, the digital retail store may be particularly attractive for smaller or new manufacturers that do not have the resources to occupy a larger shelf space.

Similarly, the retailer can benefit from using the digital retail store because it can potentially stock many more items while still providing adequate visibility for each stocked product. For example, a retailer may desire to stock a particular brand of a product but may only have a small section of the shelf available for the particular brand. The small section may not be sufficient to provide the necessary level of visibility for the product which would therefore result in the product being “hidden” among the other products on the shelf. However, if the retailer can offer to include the particular brand of the product in its digital retail store in exchange for the digital slotting fee, the added visibility provided by the digital retail store may make the small section of shelf adequate for the manufacturer's product. Specifically, because the digital retail store can inform a customer searching for a type of product that the particular brand of the product is available at the physical retail store, the customer can be directed to the particular brand on the shelf. In this way, the amount of shelf space that a particular brand of a product occupies can have less influence on the customer's decision to purchase a particular brand of the product.

In some embodiments, the digital retail store can require a digital slotting fee for each stock keeping unit (SKU) that a manufacturer desires to include in the digital retail store. Therefore, the manufacturer can be billed a digital slotting fee based on the number of the manufacturer's SKUs that are made available in the digital retail store. As stated above, in some embodiments, the digital retail store can be personalized for each customer. In such cases, a digital slotting fee can be charged for each SKU to be included in each personalized digital retail store. Such digital slotting fees can be charged on a periodic basis such as monthly, yearly, etc.

In some embodiments, the amount of the digital slotting fee charged for a product can be based on how prominently the product is featured in the digital retail store. For example, a base digital slotting fee can be charged for inclusion of the product in the digital retail store, while a higher digital slotting fee can be charged to have a product featured on a main user interface of the digital retail store, or for having the product featured in search results. In this way, a manufacturer can pay a higher digital slotting fee to ensure that its products have a greater visibility within the digital retail store.

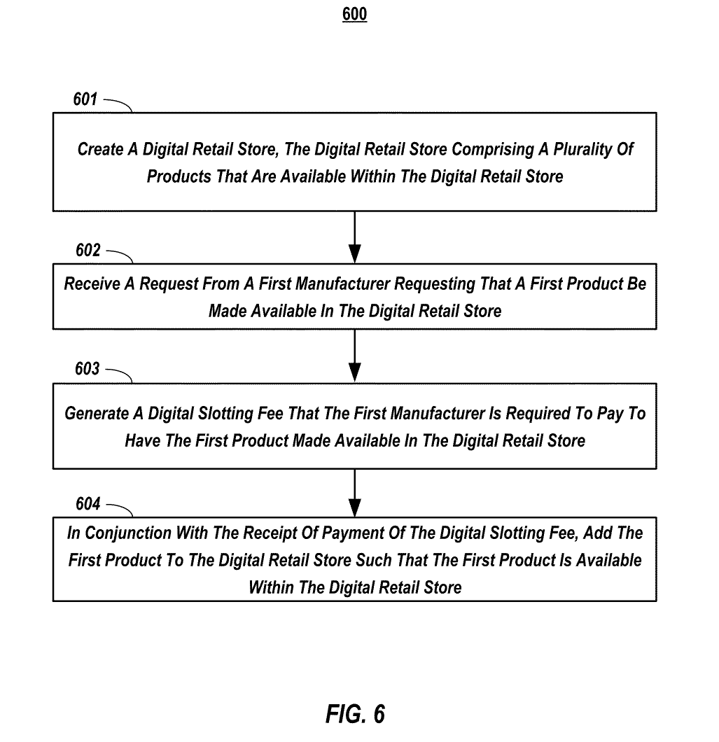

FIG. 6 illustrates a flowchart of an example method 600 for providing a digital retail store featuring digital slotting fees for inclusion of products in the digital retail store. Method 600 can be implemented by a server computing system such as server computing system 101 shown in FIG. 1.

Method 600 includes an act 601 of creating a digital retail store, the digital retail store comprising a plurality of products that are available within the digital retail store. For example, server computing system 101 can create a digital retail store that includes a plurality of products. In some embodiments, the products are available within an associated physical retail store.

Method 600 includes an act 602 of receiving a request from a first manufacturer requesting that a first product be made available in the digital retail store.

Method 600 includes an act 603 of generating a digital slotting fee that the first manufacturer is required to pay to have the first product made available in the digital retail store. For example, the digital slotting fee can be based on a number of products that the first manufacturer desires to have made available within the digital retail store.

Method 600 includes an act 604 of in conjunction with the receipt of payment of the digital slotting fee, adding the first product to the digital retail store such that the first product is available within the digital retail store. For example, the first product can be made available within the digital retail store so that customers can view the first product when interacting with a user interface of the digital retail store.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A method, performed by a server computing system, for providing a digital retail store featuring digital slotting fees for inclusion of products in the digital retail store, the method comprising:
creating, by the server computing system, a digital retail store, the digital retail store comprising a plurality of products that are available within the digital retail store;
receiving a request from a first manufacturer requesting that a first product be made available in the digital retail store;
generating a digital slotting fee that the first manufacturer is required to pay to have the first product made available in the digital retail store; and
in conjunction with the receipt of payment of the digital slotting fee, adding the first product to the digital retail store such that the first product is available within the digital retail store.

2. The method of claim 1, wherein the digital retail store is associated with a physical retail store such that the plurality of products available within the digital retail store are available within the physical retail store.

3. The method of claim 2, wherein the plurality of products available within the digital retail store does not include all products available within the physical retail store.

4. The method of claim 1, further comprising:
generating a first user interface representing the digital retail store; and
sending the first user interface to a client computing device for display on the client computing device.

5. The method of claim 4, wherein the client computing device is located within a physical retail store with which the digital retail store is associated.

6. The method of claim 4, further comprising:
receiving, from the client computing device, customer input that was received by the client computer device, the customer input requesting to view a particular type of product that is available within the physical retail store;
identifying one or more products of the particular type that are available within the digital retail store;
generating a second user interface that includes the one or more identified products; and
sending the second user interface to the client computing device for display on the client computing device.

7. The method of claim 6, wherein the one or more identified products that are included in the second user interface comprise less than all of the products of the particular type that are available in the physical retail store.

8. The method of claim 1, wherein the digital retail store is personalized for a particular customer, and wherein the digital slotting fee is calculated based on the first product being available within the personalized digital retail store.

9. The method of claim 8, wherein the digital slotting fee is calculated based on the first product being featured more prominently than other products within one or more user interfaces of the digital retail store.

10. The method of claim 1, wherein the digital slotting fee is based on the number of SKUs that the first manufacture requests are made available within the digital retail store.

11. The method of claim 1, wherein the digital slotting fee is generated periodically based on the number of products that the first manufacturer requests are made available within the digital retail store during the corresponding period.

12. One or more computer storage media storing computer executable instructions implementing a digital retail store featuring digital slotting fees, the digital retail store comprising:
computer executable instructions defining a plurality of products that are available within the digital retail store;
computer executable instructions which when executed generate one or more user interfaces for displaying one or more of the products available within the digital retail store; and
computer executable instructions which when executed calculate a digital slotting fee to charge to a manufacturer, the digital slotting fee being based on the number of the manufacturer's products that are made available within the digital retail store.

13. The computer storage media of claim 12, wherein the digital retail store represents products available within a physical retail store, and wherein less than all of the products available within the physical retail store are made available within the digital retail store.

14. The computer storage media of claim 12, further comprising:
computer executable instructions which when executed remove products from the digital retail store when the digital slotting fee for the products has not been paid.

15. The computer storage media of claim 12, further comprising:
computer executable instructions which when executed add new products to the digital retail store when a digital slotting fee for the new products is paid.

16. A system for implementing a digital retail store featuring digital slotting fees, comprising:
a server computing system comprising one or more processors and memory storing:
computer executable instructions defining a plurality of products that are available within the digital retail store;
computer executable instructions which when executed generate user interface for displaying one or more of the products available within the digital retail store; and
computer executable instructions which when executed calculate a digital slotting fee to charge to a manufacturer, the digital slotting fee being based on the number of the manufacturer's products that are made available within the digital retail store; and
one or more client computing devices for displaying the one or more user interfaces.

17. The system of claim 16, wherein at least one of the one or more client computing devices are located within a physical retail store with which the digital retail store is associated.

18. The system of claim 17, wherein at least one of the one or more client computing devices is mounted to a shelf in the physical retail store.

19. The system of claim 17, wherein less than all of the products available within the physical retail store are made available within the digital retail store.

20. The system of claim 17, wherein the memory of the server computing system further stores:
computer executable instructions which when executed add new products to the digital retail store when a digital slotting fee for the new products is paid, the new products also being available within the physical retail store.
